(19) United States
(12) Patent Application Publication
(10) Pub. No.: US 2004/0222165 A1
(43) Pub. Date: Nov. 11, 2004

(54) Flexible film packaging for use with ozone sterilization applications

(75) Inventors: Catherine Michocki, New York, NY (US); Gary J. Albaum, Croton-on-Hudson, NY (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/434,102

(22) Filed: May 8, 2003

(51) Int. Cl. B01D 61/00

(52) U.S. Cl. 210/760

(57) ABSTRACT

The present invention provides methods of packaging ozone sterilized products in plastic film container wherein adverse organoleptic reactions or interactions are substantially reduced and preferably essentially eliminated. More specifically, the present invention relates to methods of packaging ozone sterilized water in plastic containers, especially flexible plastic film pouches having an inner polyethylene liner, wherein adverse organoleptic reactions or interactions are substantially reduced and preferably essentially eliminated. Preferably, the inner polyethylene liner is manufactured from polyethylene which does not contain slip agents or other organic processing aids which may react with ozone.

### FIELD OF THE INVENTION

This invention relates to methods of packaging ozone sterilized products in plastic film container wherein adverse organoleptic reactions or interactions are substantially reduced and preferably essentially eliminated. More specifically, the present invention relates to methods of packaging ozone sterilized water in plastic containers, especially flexible plastic film pouches having an inner polyethylene liner, wherein adverse organoleptic reactions or interactions are substantially reduced and preferably essentially eliminated.

### BACKGROUND OF THE INVENTION

Although it use in the United States is relatively recent, ozone has been used to disinfect drinking water, especially municipal water supplies, for over 100 years in other parts of the world (most notably Europe). Ozone is a strong oxidating agent and is very effective in killing microogranisms that may be present in water and ultimately forms oxygen as a by-product. Thus, ozone can be considered an environmentally friendly approach to water treatment. Since it is unstable (e.g., half-life of about 24 minutes at about 20° C. and pH 7 in potable tap water), it is generally generated on-site and used immediately. Examples of the use of ozone in water treatment, alone or in combinations with other treatment regimes, can be found in U.S. Pat. No. 6,464,877 (Oct. 15, 2002), U.S. Pat. No. 6,402,945 (Jun. 11, 2002), U.S. Pat. No. 6,267,878 (Jul. 31, 2001), U.S. Pat. No. 6,180,014 (Jan. 30, 2001), U.S. Pat. No. 6,153,111 (Nov. 28, 2000), U.S. Pat. No. 6,153,151 (Nov. 28, 2000), U.S. Pat. No. 6,152,997 (Nov. 28, 2000), U.S. Pat. No. 6,149,820 (Nov. 21, 2000), U.S. Pat. No. 6,090,294 (Jul. 18, 2000), U.S. Pat. No. 6,053,535 (Feb. 29, 2000), U.S. Pat. No. 6,030,526 (Feb. 29, 2000), U.S. Pat. No. 5,492,633 (Feb. 20, 1996), U.S. Pat. No. 5,478,533 (Dec. 26, 1995), U.S. Pat. No. 5,433,866 (Jul. 18, 1995), and U.S. Pat. No. 5,397,461 (Mar. 14, 1995), all of which are hereby incorporated by reference.

More recently, ozone has been used to treat bottled water. In the bottled water industry, ozone was generally viewed as the magic oxidant which could be used to sterilize or disinfect the water, the bottling equipment, the container, the sealing cap or other mechanism, the container headspace, and the like and then decompose to oxygen and thus disappear without taste or odor defects. This view was generally correct so long as the container consisted of glass. As the industry moved to other types of containers, especially plastic containers, problems associated with taste and odor defects arose. Such taste defects have been described as “slight melted plastic taste” and were generally thought to be derived from reactions of the ozone with the polymers used to prepare the plastic containers.

Thus, it would be desirable to provide methods for treating bottled water to be stored in plastic containers, especially polyethylene-lined containers, wherein taste and odor defects are significantly reduced and preferably eliminated. The present invention provides such methods.

### SUMMARY OF THE INVENTION

The present invention provides a method of packaging ozone sterilized products in plastic film container wherein adverse organoleptic reactions or interactions are substantially reduced and preferably essentially eliminated. More specifically, the present invention provides a method of packaging ozone sterilized water in plastic containers, especially flexible plastic film pouches having an inner polyethylene liner which contacts the water, wherein adverse organoleptic reactions or interactions are substantially reduced and preferably essentially eliminated. The methods of the present invention use polyethylene packaging materials, especially polyethylene films, which do not react with the ozone used to sterilize the water prior to packaging. The present methods provide bottled beverages, especially bottled water, with improved organoleptic properties, especially taste and odor, as compared to similarly bottled water in conventional packaging materials which contain organic processing aids or additives (e.g., slip agents, anti-blocking agents, anti-static agents, and the like).

In one embodiment, the present invention provides a method for packaging ozone treated water, said method comprising (1) treating water with ozone in an effective amount to sterilize the water, (2) placing the ozone treated water in a polyethylene inner cavity of a plastic container within a time in which the ozone retains sterilizing activity, and (3) sealing the ozone treated water within the polyethylene inner cavity, wherein the polyethylene inner cavity which contacts the ozone treated water is prepared using a polyethylene resin which is essentially free of organic additives which, when contacted with ozone, react to produce adverse organoleptic defects, whereby the ozone treated water in the polyethylene inner cavity is sterilized without the generation of adverse organoleptic defects due to reaction of the ozone with the chemical additives.

In still another embodiment, the present invention provides a method for packaging ozone treated water suitable for human consumption, said method comprising (1) treating water with ozone in an effective amount to sterilize the water, (2) placing the ozone treated water in a polyethylene inner cavity of a plastic container within a time in which the ozone retains sterilizing activity, and (3) sealing the ozone treated water within the polyethylene inner cavity, wherein the polyethylene inner cavity which contacts the ozone treated water is prepared using a polyethylene resin which is essentially free of slip agents which, when contacted with ozone, react to produce adverse organoleptic defects, whereby the ozone treated water in the polyethylene inner cavity is sterilized without the generation of adverse organoleptic defects due to reaction of the ozone with slip agents.

### BRIEF DESCRIPTION OF THE DRAWINGS

FIG. 1 illustrates a preferred water processing scheme for use in the present invention.

### DETAILED DESCRIPTION OF THE INVENTION

The present invention provides a method of packaging ozone sterilized products in plastic film container wherein adverse organoleptic reactions or interactions are substantially reduced and preferably essentially eliminated. More specifically, the present invention provides a method of packaging ozone sterilized water in plastic containers, especially flexible plastic film pouches having an inner polyethylene liner which contacts the water, wherein adverse organoleptic reactions or interactions are substantially reduced and preferably essentially eliminated. The methods of the present invention use polyethylene packaging materials, especially polyethylene films, which do not react with the ozone used to sterilize the water prior to packaging. The present methods provide bottled beverages, especially bottled water, with improved organoleptic properties, especially taste and odor, as compared to similarly bottled beverages or water in conventional packaging materials which contain organic processing aids or additives (e.g., slip agents, anti-blocking agents, anti-static agents, and the like).

The present invention provides polyethylene containers from which organic materials which might react with the ozone disinfectant to produce organoleptic defects are removed from the polyethylene film which will contact the water. By removal of such organic materials—generally conventional polyethylene processing aids such as slip agents, anti-blocking agents, anti-static agents, and the like—from the plastic resin used to prepare that portion of the container which will contact the ozonated water, organoleptic defects can be significantly reduced and, in some cases, essentially eliminated.

Slip agents are generally used in the manufacture of polyethylene films to impart slip and anti-block properties to the film surface. Such slip agents generally provide an internal reservoir of lubrication within the film which migrates to the surface of the film shortly after formation of the film. Once on the surface, the slip agents tends to form a soft lubricating layer which tends to eliminate surface imperfections. This layer helps to prevent sticking and blocking by effectively separating adjacent film surfaces and lowering the coefficient of friction. The most commonly used slip agents used in the manufacture of polyethylene and especially polyethylene films are long-chain fatty acid amides such as stearamide, oleamide and erucamide fatty acid derivatives prepared by the amidation of stearic acid, oleic acid, and erucic acid, respectively.

It has now been found that significant organoleptic defects can be generated by the reaction of ozone with these primary amide slip agents. For polyethylene with erucamide slip agents, oxidation reactions with ozone result in the formation of significant levels of nonanal (i.e., n-nonyl aldehyde) and other volatile compounds.

Thus, by proper selection of the polyethylene film used to form at least that portion of the plastic container which contacts the water, bottled water with significantly reduced organoleptic defects. In one embodiment, polyethylene films which do not contain slip agent are used to form that portion of the plastic container which contacts the water. Slip agents, since they tend to migrate to the polyethylene surfaces, are especially important contributors to the observed organoleptic defects due to ozone treatment. Nonetheless, it is also preferred that polyethylene which does not contain slip agents, as well as other organic additives or processing aids, is used in the present invention. By eliminating such slip agents (and preferably other organic processing aids as well), potential adverse ozone reaction products are eliminated, thereby providing a more organoleptic pleasing bottled water product. Preferably, polyethylene films prepared from master batches of monomer which do not contain slip agents or other organic processing aids which may react with ozone are preferred.

In the practice of this invention, potable water is treated with ozone using conventional techniques. If needed or desired, the water is treated with other purification techniques (e.g., reverse osmosis, distillation, filtration, charcoal or carbon treatment, UV irradiation, and the like) prior to ozone treatment. Of course, such earlier purification steps should not introduce agents into the water which would react with the ozone to produce organoleptic defects. Preferably, the water is treated with reverse osmosis prior to the ozone treatment in the methods of this invention.

Generally, the potable water should be treated with ozone in an amount sufficient to kill pathogens or microogranisms that may be present in water and provide a sterilized water product without the generation of adverse organoleptic defects. Generally, the amount of ozone is preferably in the range of about 0.1 to about 0.4 ppm, more preferably about 0.2 to about 0.4 ppm, and is maintained at that level for about 30 to about 40 minutes. Ozone can be provided with conventional ozone generators, many of which are commercially available. Once the water is treated with ozone, it should be packaged in a suitable polyethylene inner cavity of a plastic container within a time in which the ozone retains sterilizing activity and then the plastic container should be sealed. Generally, the treated water should be placed within the polyethylene inner cavity and sealed therein within about 5 minutes, and preferably within about 1 minute, of the ozone treatment in order to insure the ozone retains sufficient sterilizing activity to sterilize any microorganisms that might be present in, or have been introduced into, the polyethylene inner cavity either through the bottling equipment or contamination of the water after the ozone treatment or the headspace above the water. Of course, efforts should be made to insure that such contamination is avoided.

Once the polyethylene inner cavity is filled with the appropriate amount of ozone treated water, the package is sealed using conventional techniques appropriate to the actual plastic materials used in the container. Any suitable plastic container can be used so long as it has a polyethylene inner cavity to contact the water which does not contain slip agents and, preferably, other organic processing aids which react with ozone to produce organoleptic defects. Thus, suitable containers include rigid plastic bottles or containers which have their inner cavities designed to receive the treated water coated or formed from polyethylene which does not contain slip agents and, preferably, other organic processing aids which react with ozone to produce organoleptic defects. Such bottles may be sealed using any suitable sealing device, including, for example, a bottle cap, which provides an effective seal over the expected shelf life of the product.

Especially preferred containers include flexible pouches having inner cavities designed to receive the treated water coated or formed from polyethylene which does not contain slip agents and, preferably, other organic processing aids which react with ozone to produce organoleptic defects. More preferably, such flexible pouches are formed from multi-layer plastic films wherein the inner film layer, which will contact the treated water, is polyethylene which does not contain slip agents and, preferably, other organic processing aids which react with ozone to produce organoleptic defects. The multilayer films may be produced by conventional techniques. One especially preferred container for use in the present invention is shown in U.S. Design Pat. No. D470,757 (Feb. 25, 2003), which is hereby incorporated by reference; of course, such a preferred container would have its inner cavity designed to container the treated water formed from polyethylene which does not contain slip agents and, preferably, other organic processing aids which react with ozone to produce organoleptic defects. Such flexible multilayer pouches are preferably sealed using ultrasonic, thermal, induction, and the like sealing techniques.

Generally, the polyethylene forming the inner cavity is about 2 to about 5 mils thick. Suitable polyethylenes include low density polyethylene (LDPE), linear low density polyethylene (LLDPE), and mixtures thereof. An especially preferred polyethylene for use in the present invention is a blend of LDPE and LLDPE.

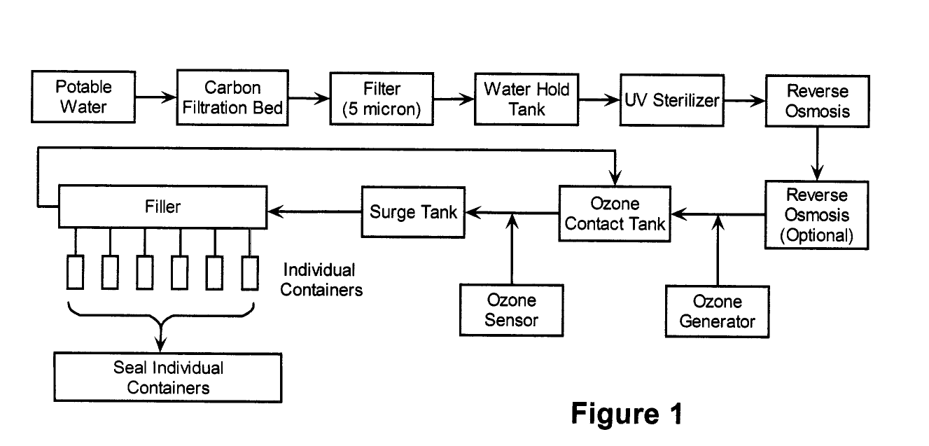

FIG. 1 illustrates a preferred process whereby water is treated with ozone and filled into suitable containers. As shown in FIG. 1, potable water is filter through a carbon filtration bed to remove chlorine and any trihalomethane which may be present. After passage through a 5 micron filter, the water is treated in an ultraviolet sterilizer to destroy microorganisms and prevent microbial growth in the reverse osmosis unit. The reverse osmosis (RO) unit (which may be a single pass or double pass unit) is designed to remove more than 99.9 percent total dissolved solids and essentially 100 percent total suspended solids. The RO water is then treated with ozone from an ozone generator in an ozone contact tank (preferably with good mixing). Generally, the concentration of ozone in the ozone contact tank is kept at about 0.4 to about 0.6 ppm ozone and the resident time of the water within the ozone contact time is about 30 to about 40 minutes (or longer) to insure effective sterilization. An ozone sensor is used to confirm proper ozone concentration within the ozone contact tank. Ozone treated water is then passed through a surge tank and then to a filling station where individual flexible pouches are filled and then sealed. Water in the filled pouches preferably contain about 0.2 to about 0.4 ppm ozone. Treated water passing through the filler station can be recycled to the ozone contact tank if desired. Although not shown, the filler station is fitted with a system whereby any gaseous ozone is removed from the area. Such gaseous ozone treatment can include, for example, a hood for ozone containment and proper venting, UV light source to destroy the ozone, adequate air circulation, and combinations thereof.

The following example is intended to illustrate the invention and not to limit it. Unless otherwise noted, all percentage are by weight. All patent and other publication listed in the present specification are incorporated by reference in their entireties.

### EXAMPLE 1

Several different flexible pouches were prepared in which the inner polyethylene layer (which will contact the bottled water) had various levels and types of slip agents. Water treated with 0.2 ppm ozone was sealed in the flexible pouches and then stored for extended periods of time at either about 70° F. or about 90° F. and then evaluated by a trained 5 member taste panel for organoleptic properties. The following examples were tested. Control: commercial bottled water in a hard polyester bottle. Sample 1: ozone treated water stored at 70° F. in polyethylene flexible pouch wherein the polyethylene contained conventional grade slip agent (i.e., erucamide). Sample 2: ozone treated water stored at 90° F. in polyethylene flexible pouch wherein the polyethylene contained conventional grade slip agent (i.e., erucamide). Sample 3: ozone treated water stored at 90° F. in polyethylene flexible pouch wherein the polyethylene contained a higher grade of slip agent (i.e., highly purified erucamide and a saturated amide slip agent). Sample 4: ozone treated water stored at 90° F. in polyethylene flexible pouch wherein the polyethylene did not contain a slip agent.

For the actual tests, each panelist first tasted the control (knowing it was the control), followed randomly by the four samples and another control (i.e., a blind control since panelist did not know its identity as compared with the first control). Samples were ranked on a 1 to 10 scale with 1 being worst, 2-3 being unacceptable, 4-6 being borderline, and 7-10 being good to excellent. After storage for nine weeks, the following results were obtained:

| Sample | Average Rating |
|---|---|
| Known Control | 10 |
| Sample 1 | 3.4 |
| Sample 2 | 4.4 |
| Sample 3 | 5.6 |
| Sample 4 | 8.2 |
| Blind Control | 8.6 |

Sample 4, the inventive sample, was essentially equivalent to the blind control.

Gas chromatography of the various samples showed nonanal in Samples 1 and 2 (high levels) and Sample 3 (lower levels); even the lowest levels of nonanal observed in Sample 3 rendered the water unacceptable. No nonanal was observed with the inventive sample (Sample 4).

We claim:

1. A method for packaging ozone treated water suitable for human consumption, said method comprising (1) treating water with ozone in an effective amount to sterilize the water, (2) placing the ozone treated water in a polyethylene inner cavity of a plastic container within a time in which the ozone retains sterilizing activity, and (3) sealing the ozone treated water within the polyethylene inner cavity, wherein the polyethylene inner cavity which contacts the ozone treated water is prepared using a polyethylene resin which is essentially free of organic additives which, when contacted with ozone, react to produce adverse organoleptic defects, whereby the ozone treated water in the polyethylene inner cavity is sterilized without the generation of adverse organoleptic defects due to reaction of the ozone with the chemical additives.

2. The method as defined in claim 1, wherein the plastic container is a flexible plastic film pouch having multiple film layers.

3. The method as defined in claim 1, wherein the polyethylene resin is essentially free of slip agents.

4. The method as defined in claim 2, wherein the polyethylene resin is essentially free of slip agents.

5. The method as define in claim 1, wherein the water is treated by reverse osmosis prior to treatment with ozone.

6. The method as define in claim 2, wherein the water is treated by reverse osmosis prior to treatment with ozone.

7. The method as define in claim 3, wherein the water is treated by reverse osmosis prior to treatment with ozone.

8. The method as define in claim 4, wherein the water is treated by reverse osmosis prior to treatment with ozone.

9. A method for packaging ozone treated water suitable for human consumption, said method comprising (1) treating water with ozone in an effective amount to sterilize the water, (2) placing the ozone treated water in a polyethylene inner cavity of a plastic container within a time in which the ozone retains sterilizing activity, and (3) sealing the ozone treated water within the polyethylene inner cavity, wherein the polyethylene inner cavity which contacts the ozone treated water is prepared using a polyethylene resin which is essentially free of slip agents which, when contacted with ozone, react to produce adverse organoleptic defects, whereby the ozone treated water in the polyethylene inner cavity is sterilized without the generation of adverse organoleptic defects due to reaction of the ozone with slip agents.

10. The method as defined in claim 9, wherein the plastic container is a flexible plastic film pouch having multiple film layers.

11. The method as define in claim 9, wherein the water is treated by reverse osmosis prior to treatment with ozone.

12. The method as define in claim 10, wherein the water is treated by reverse osmosis prior to treatment with ozone.

13. The method as define in claim 11, wherein the water is treated by reverse osmosis prior to treatment with ozone.

14. The method as define in claim 12, wherein the water is treated by reverse osmosis prior to treatment with ozone.

15. A method for packaging ozone treated water suitable for human consumption, said method comprising (1) passing potable water through a carbon filtration bed to obtain filtered water, (2) passing the filtered water through an UV sterilizer to obtain UV sterilized water, (3) subjecting the UV sterilized water to a single pass or double pass reverse osmosis treatment to obtain reverse osmosis water, (4) treating the reverse osmosis water with ozone in an effective amount to sterilize the reverse osmosis water and to obtain ozone treated water, (5) placing the ozone treated water in a polyethylene inner cavity of a plastic container within a time in which the ozone retains sterilizing activity, and (6) sealing the ozone treated water within the polyethylene inner cavity, wherein the polyethylene inner cavity which contacts the ozone treated water is prepared using a polyethylene resin which is essentially free of slip agents which, when contacted with ozone, react to produce adverse organoleptic defects, whereby the ozone treated water in the polyethylene inner cavity is sterilized without the generation of adverse organoleptic defects due to reaction of the ozone with slip agents.

16. The method as defined in claim 15, wherein the plastic container is a flexible plastic film pouch having multiple film layers.

17. The method as defined in claim 15, wherein the effective amount ozone used to sterilize the reverse osmosis water is about 0.4 to about 0.6 ppm ozone.

18. The method as defined in claim 16, wherein the effective amount ozone used to sterilize the reverse osmosis water is about 0.4 to about 0.6 ppm ozone.
